(19) United States
(12) Patent Application Publication
(10) Pub. No.: US 2024/0367023 A1
(43) Pub. Date: Nov. 7, 2024

(54) HANDLEBAR EXTENSION APPARATUS AND ASSOCIATED BICYCLE EXERCISE ARRANGEMENT

(71) Applicants: Peter Gregory, White Gum Valley (AU); Andrew Johnson, White Gum Valley (AU)

(72) Inventors: Peter Gregory, White Gum Valley (AU); Andrew Johnson, White Gum Valley (AU)

(21) Appl. No.: 18/562,158

(22) PCT Filed: May 18, 2022
(86) PCT No.: PCT/AU2022/050477

§ 371 Date: Nov. 17, 2023

(30) Foreign Application Priority Data
May 19, 2021 (AU) 2021901504

(51) Int. Cl. A63B 69/16

(52) U.S. Cl. CPC A63B 69/16; A63B 2069/163; A63B 2069/165

(57) ABSTRACT

Provided is bicycle handlebar extension apparatus (10) comprising a strut arrangement (12) having a lower end (14) configured to releasably engage a front wheel (34) of a bicycle (8) and an upper end (18) configured to releasably engage a handlebar stem (20) of said bicycle (8). Apparatus (10) also includes a brace (22) hingedly attached at a bottom end (24) thereof to the upper end (18) of the strut arrangement (12), said brace (22) defining at a top end (26) thereof a pivotable receptacle (28) configured to receive handlebars (30). In this manner, the strut arrangement (12) operatively engaged with the front axle (16) and handlebar stem (20) provides stationary stability to the bicycle (8) whilst angles between the strut arrangement (12), brace (22) and receptacle (28) are adjustable to facilitate desired rider ergonomics.

### TECHNICAL FIELD

This invention relates to the field of cycling, in general, and more specifically to a bicycle handlebar extension apparatus and an associated bicycle exercise arrangement.

### BACKGROUND ART

The following discussion of the background art is intended to facilitate an understanding of the present invention only. The discussion is not an acknowledgement or admission that any of the material referred to is or was part of the common general knowledge as at the priority date of the application.

The field of cycling, also called bicycling or biking, is well-known in the art and is generally the use of bicycles for transport, recreation, exercise or sport. In addition to cycling for transport or other practical utilitarian purposes, cycling for exercise also provides a variety of health benefits. The World Health Organization (WHO) states that cycling can reduce the risk of cancers, heart disease, and diabetes that are prevalent in sedentary lifestyles. Cycling on stationary bikes have also been used as part of rehabilitation for lower limb injuries, particularly after hip surgery. Individuals who cycle regularly have also reported mental health improvements, including less perceived stress and better vitality.

As a form of exercise or sport, ongoing cycling training is popular with cyclists to maintain fitness and technique. Amongst cycling enthusiasts, a stationary bicycle trainer stand (also known as an indoor bike trainer or turbo trainer) is often used to allow stationary and/or indoor training or exercise on a bicycle, such as during inclement weather, at night time, to recuperate from injury, or the like.

Such indoor bike trainers generally comprise a supporting frame on which a rear axle of a bicycle can be safely supported off the floor to allow stationary cycling, and may further include some manner of resistance configured to engage with a rear wheel of the bicycle to provide resistance when pedaling the bicycle. Such resistance may include a friction wheel with an air or fluid resistance device, a magnetic, a weighted flywheel, etc. Often, the resistance device is adjustable to allow specific training or exercise regimes to be followed, as desired.

Applicant has identified a shortcoming in the art of such indoor bicycle trainers, particularly related to cyclist comfort, ergonomics and stability. In particular, using an indoor bike trainer for longer periods of time can be uncomfortable, especially when used on ‘road’ or ‘racing’ bicycles, which typically have drop handlebars.

Although a hunched over position may be aerodynamically advantageous if the rider is in motion, extended periods of being hunched over handlebars, such as when using the bicycle on a stationary indoor trainer, may cause the rider to experience considerable discomfort, particularly when there is no airflow from moving forward to alleviate some pressure on the cyclist's back, shoulders and arms. For example, the rider's back may become sore or the rider's shoulders or hands may become fatigued from supporting the rider's upper body above the handlebars when stationary on a bike trainer. Similarly, when a cyclist is using an indoor trainer to recuperate from injury or for rehabilitation purposes, comfort and ergonomics become important.

Prior art solutions for addressing cyclist comfort, generally when on-road, are known. Such solutions generally take the form of a handlebar extension to allow a more upright seating position. Some examples of such existing handlebar extensions are shown in US 2011/0215549 A1 to Plainfield, U.S. Pat. No. 5,195,394 to Latta, US 2020/0207439 A1 to Dawe and EP 1877300 B1.

However, none of the prior art devices facilitates stability for use on an indoor bike trainer, particularly where lack of both wheels rotating and bicycle forward motion promotes stability due to gyroscopic effects and angular momentum. In addition, such conventional devices generally clamp to a bicycle's handlebar and can interfere with normal and safe operation without first removing the device, which can be arduous and time-consuming.

The current invention was conceived with these shortcomings in mind in an attempt to provide a handlebar extension apparatus which facilitates rider comfort as well as safe and stable operation of a bicycle typically when used on an indoor bicycle trainer.

### SUMMARY OF THE INVENTION

According to a first aspect of the invention there is provided a bicycle handlebar extension apparatus comprising:
a strut arrangement having a lower end configured to releasably engage a front wheel of a bicycle and an upper end configured to releasably engage a handlebar stem of said bicycle; and
a brace hingedly attached at a bottom end thereof to the upper end of the strut arrangement, said brace defining at a top end thereof a pivotable receptacle configured to receive handlebars, wherein the strut arrangement operatively engaged with the front axle and handlebar stem provides stationary stability to the bicycle whilst angles between the strut arrangement, brace and receptacle are adjustable to facilitate desired rider ergonomics.

Typically, the strut arrangement comprises two struts operatively locatable on either side of a front wheel of the bicycle in order to straddle said wheel.

In an embodiment, the strut arrangement is configured to abut against a frame of the bicycle in order to impede a front wheel thereof from swivelling, i.e. turning from side-to-side.

In an embodiment, the strut arrangement engages with an axle of the front wheel.

Typically, the lower end of the strut arrangement is configured to releasably engage the front axle by means of a quick-release attachment.

In an embodiment, the strut arrangement is configured to engage the front axle by defining axle apertures for receiving said axle therethrough.

In an embodiment, the strut arrangement is biased to sandwich the front axle between respective struts straddling the front wheel.

In an embodiment, the strut arrangement includes a clamp assembly configured to clamp onto the front wheel.

Typically, the clamp assembly is positioned between the two struts proximate the upper end of the strut arrangement, the clamp assembly arrestably slidable along the strut arrangement to facilitate clamping onto front wheel of varying sizes.

Typically, the clamp assembly is arrestable by means of an infinitely adjustable releasable detent.

In an embodiment, the strut arrangement includes a front wheel cradle at the lower end thereof, said cradle configured to receive the front wheel therein.

In an embodiment, the front wheel cradle defines a support foot configured to support the bicycle on a level surface.

In an embodiment, the strut arrangement is configured to be lengthwise adjustable to enable fitment to various sized bicycles, e.g. telescoping struts, or the like.

In an embodiment, the upper end of the strut arrangement is configured to releasably engage the handlebar stem by defining a friction-fit or interference-fit clip to clip onto said handlebar stem.

In an embodiment, the upper end of the strut arrangement is configured to releasably engage the handlebar stem by means of a suitable clamp.

Typically, the brace comprises two beams extending from the strut arrangement to the handlebar receptacle.

In an embodiment, the brace is configured to be lengthwise adjustable to enable ergonomic adjustment e.g. telescoping brace, or the like.

In an embodiment, the pivotable receptacle is configured to receive a variety of bicycle handlebars, as required.

In an embodiment, the apparatus includes handlebars received within the receptacle.

In an embodiment, the handlebars comprise triathlon bars.

Typically, the hinge at the bottom end of the brace and the pivotable receptacle are adjustable and releasably securable in order to adjust said angles between the strut arrangement, brace and receptacle.

According to a second aspect of the invention there is provided a bicycle exercise arrangement comprising:
a bicycle mounted on a stationary bicycle trainer stand; and
a bicycle handlebar extension apparatus comprising a strut arrangement having a lower end releasably engaged with a front wheel of the bicycle and an upper end releasably engaged with a handlebar stem of said bicycle, and a brace hingedly attached at a bottom end thereof to the upper end of the strut arrangement, said brace defining at a top end thereof a pivotable receptacle configured to receive handlebars, wherein the strut arrangement operatively engaged with the front axle and handlebar stem provides stationary stability to the bicycle whilst angles between the strut arrangement, brace and receptacle are adjustable to facilitate desired rider ergonomics.

According to a third aspect of the invention there is provided a bicycle exercise arrangement comprising a bicycle including handlebar extension apparatus in accordance with the first aspect of the invention.

According to a further aspect of the invention there is provided bicycle handlebar extension apparatus and a bicycle exercise arrangement substantially as herein described and/or illustrated.

### BRIEF DESCRIPTION OF THE DRAWINGS

The description will be made with reference to the accompanying drawings in which:

FIG. 1 is a diagrammatic front-side perspective view representation of a bicycle exercise arrangement, in accordance with aspects of the present invention, comprising bicycle handlebar extension apparatus, in accordance with further aspects of the present invention;

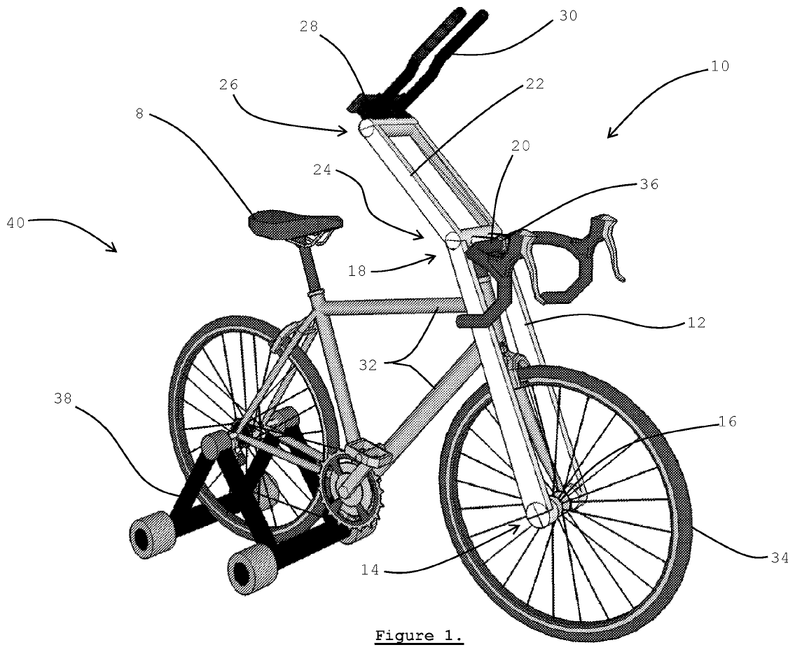

FIG. 2 is a diagrammatic side-view representation of the bicycle exercise arrangement and bicycle handlebar extension apparatus of FIG. 1;

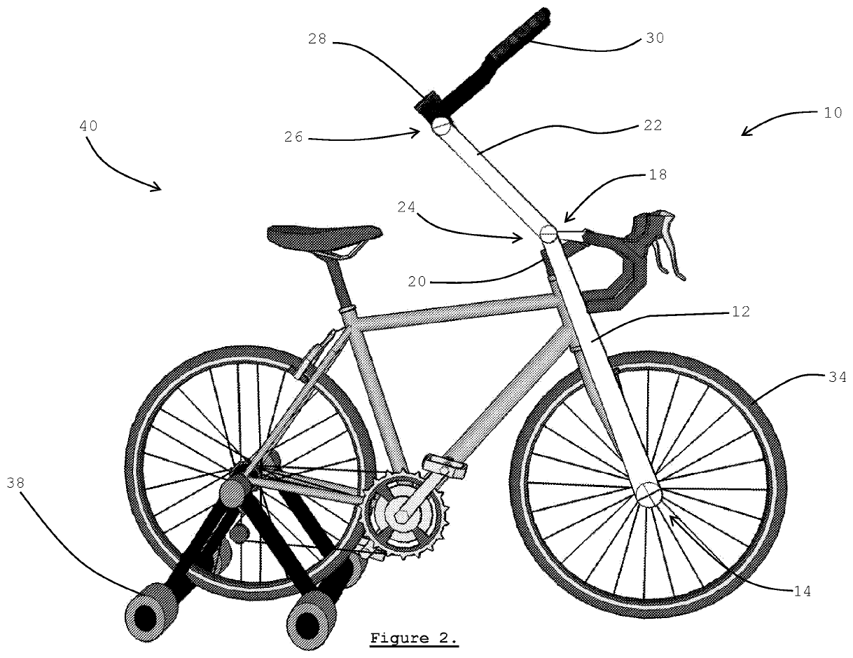

FIG. 3 is diagrammatic front-side perspective view representation of the bicycle exercise arrangement and bicycle handlebar extension apparatus of FIG. 1;

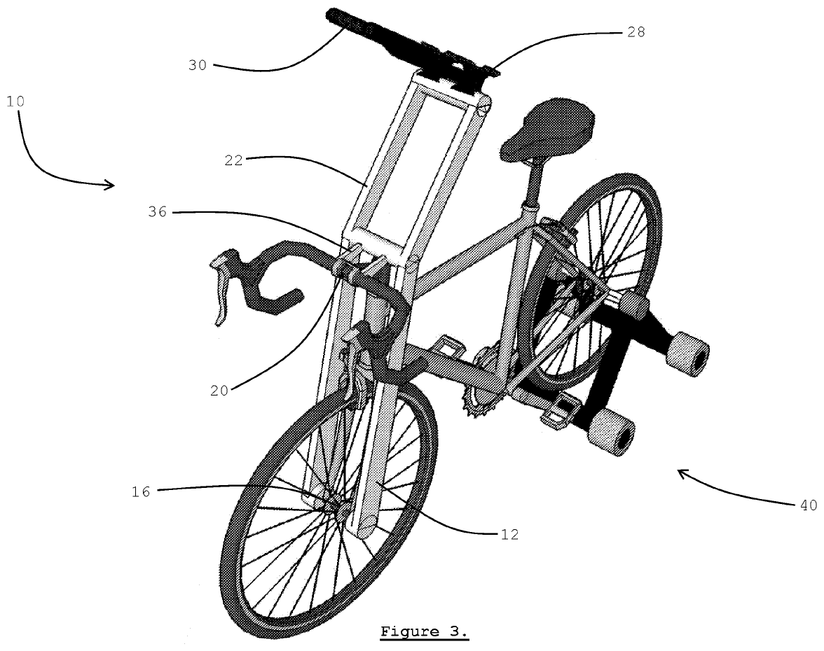

FIG. 4 is a diagrammatic bottom-side perspective view representation of the bicycle exercise arrangement and bicycle handlebar extension apparatus of FIG. 1;

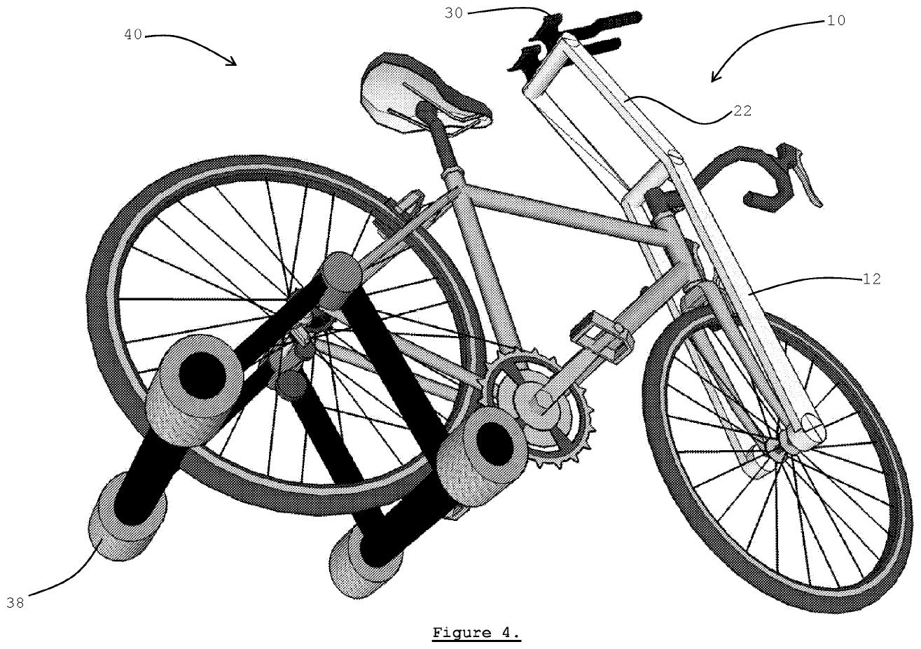

FIG. 5 is a diagrammatic front-side perspective view representation of a further embodiment of the bicycle handlebar extension apparatus, in accordance with aspects of the present invention; and

FIG. 6 is a diagrammatic front-side perspective view representation of the bicycle handlebar extension apparatus of FIG. 5.

### DETAILED DESCRIPTION OF EMBODIMENTS

Further features of the present invention are more fully described in the following description of several non-limiting embodiments thereof. This description is included solely for the purposes of exemplifying the present invention to the skilled addressee. It should not be understood as a restriction on the broad summary, disclosure or description of the invention as set out above.

In the figures, incorporated to illustrate features of the example embodiment or embodiments, like reference numerals are used to identify like parts throughout. Additionally, features, mechanisms and aspects well-known and understood in the art will not be described in detail, as such features, mechanisms and aspects will be within the understanding of the skilled addressee.

The present invention described herein broadly provides for a bicycle handlebar extension apparatus 10 and an associated bicycle exercise arrangement 40. Such apparatus 10 finds particular application on providing stability and ergonomics when used with a bicycle 8 supported on an indoor bicycle trainer 38, although such use is non-limited.

Referring now to the accompanying figures, there is shown one embodiment of such bicycle handlebar extension apparatus 10. In the exemplified embodiment, apparatus 10 typically comprises a strut arrangement 12 and a brace 22 with handlebar receptacle 28 for operatively receiving handlebars 30.

The strut arrangement 12 has a lower end 14 which is configured to releasably engage a front axle 16 of a bicycle 8 and an upper end 18 configured to releasably engage a handlebar stem 20 of said bicycle 8, as shown.

In the exemplified embodiment, the strut arrangement 12 comprises two struts operatively locatable on either side of a front wheel 34 of the bicycle 8 in order to straddle said wheel 34, as shown. In an embodiment, the strut arrangement 12 may be configured to abut against a frame 32 of the bicycle 8, for example in order to impede the front wheel 34 from turning, to provide additional stability to apparatus 10, etc.

Typically, the lower end 14 of the strut arrangement 12 is configured to releasably engage the front axle 16 by means of a quick-release attachment, as known in the art. Similarly, the strut arrangement 12 may be configured to engage the front axle 16 by defining axle apertures for receiving said axle 16 therethrough, or the like. In such an embodiment, the strut arrangement 12 may be biased to sandwich the front axle 16 between the respective struts straddling the front wheel 34.

In one embodiment, the strut arrangement 12 is configured to be lengthwise adjustable to enable fitment to various sized bicycles, e.g. telescoping struts, or the like. The upper end 18 of the strut arrangement 12 is typically configured to releasably engage the handlebar stem 20 by defining a friction-fit or interference-fit clip to clip onto said handlebar stem 20. In an embodiment, the upper end 18 of the strut arrangement 12 is configured to releasably engage the handlebar stem 20 by means of a suitable clamp. Variations hereon are possible and within the scope of the present invention.

Apparatus 10 also includes a brace 22 which is hingedly attached at a bottom end 24 thereof to the upper end 18 of the strut arrangement 12, as shown. The brace 22 further defines at a top end 26 thereof a pivotable receptacle 28 which is configured to receive handlebars 30.

In the exemplified embodiment, the brace 22 comprises two beams extending from the strut arrangement 12 to the handlebar receptacle 28. In an embodiment, the brace 22 is configured to be lengthwise adjustable to enable ergonomic adjustment e.g. telescoping brace members, or the like. Typically, the hinge at the bottom end 24 of the brace 22 and the pivotable receptacle 28 at the top end 26 are adjustable and releasably securable in order to adjust angles between the strut arrangement 12, brace 22 and receptacle 28.

In this manner, the strut arrangement 12 can be operatively engaged with the front axle 16 and handlebar stem 22 to provide stationary stability to the bicycle 8 whilst the angles between the strut arrangement 12, brace 22 and receptacle 28, i.e. handlebars 30, are adjustable to facilitate desired rider ergonomics.

In an embodiment, the pivotable receptacle 28 is configured to receive a variety of bicycle handlebars, as required. In the exemplified embodiment, the apparatus 10 includes handlebars 30 received within the receptacle 28, such as triathlon bars.

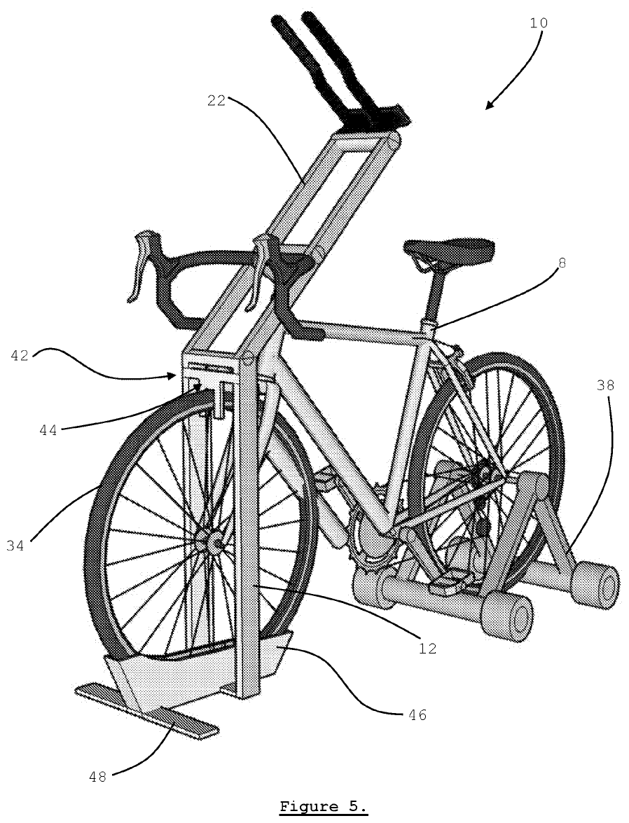

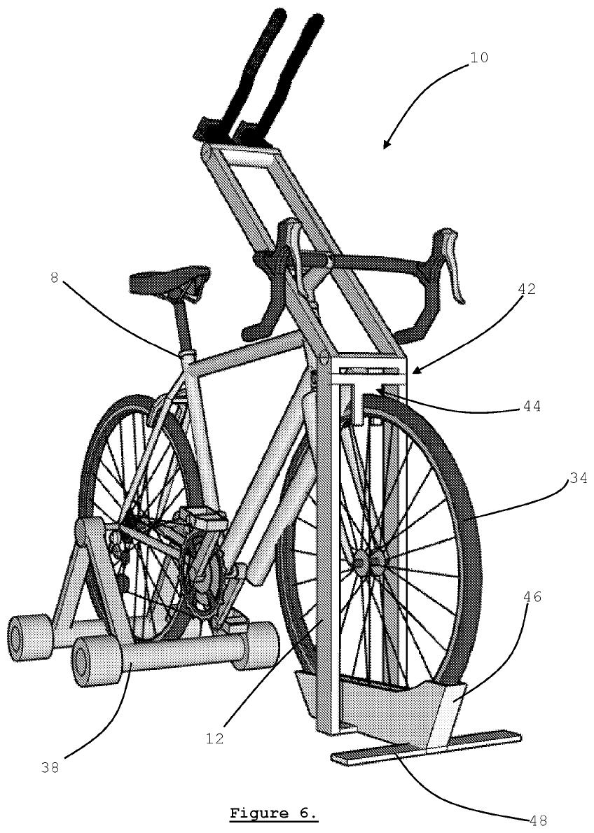

With reference now to FIGS. 5 and 6 of the accompanying figures, the skilled addressee is to appreciate that variations are possible in the manner in which the strut arrangement 12 releasably engages the front wheel 34 of bicycle 8. In the exemplified embodiment, the strut arrangement 12 includes a clamp assembly 42 which is configured to clamp onto the front wheel 34, as shown. Typically, the clamp assembly 42 is positioned between the two struts proximate the upper end 18 of the strut arrangement 12, as shown, with the clamp assembly 42 configured to be arrestably slidable along the strut arrangement 12 to facilitate clamping onto front wheels of varying sizes. The clamp assembly 42 typically includes an abutment surface, such as a rubber pad or the like, which is urged against the wheel 34 to clamp the wheel 34 in place. The clamp assembly 42 is typically arrestable by means of an infinitely adjustable releasable detent 44, such as a ratchet mechanism to facilitate clamping onto the wheel.

In such an embodiment, the strut arrangement 12 typically also includes a front wheel cradle 46 at the lower end 14 thereof, as shown, with the cradle 46 configured to receive the front wheel 34 therein. In an embodiment, the front wheel cradle 46 also defines a support foot 48 which is configured to support the bicycle on a level surface.

It is further to be appreciated that the present invention also includes a bicycle exercise arrangement 40 which comprises the bicycle 8 mounted on a stationary bicycle trainer stand 38 with apparatus 10, as described herein, fitted thereto.

While the present invention described herein was generally done so in reference to a bicycle 8, the skilled addressee is to appreciate that said apparatus 10 may find similar application on cycles other than conventional two-wheeled cycles, such as tricycles, quadricycles and/or similar human-powered vehicles. Accordingly, suitable variations on the apparatus 10 and arrangement 40 described herein are possible and within the scope of the present invention.

Applicant believes it particularly advantageous that the present invention provides for apparatus 10 configured to enable a more upright body position for a cyclist, particularly when using an indoor trainer 38. Apparatus 10 is generally able to decrease loads on the cyclist's lower back, neck, and upper limbs during use as compared to conventional handlebars. Apparatus 10 is further adaptable to be fitted to most bicycles and is fully adjustable to suit any desired ergonomics of a cyclist.

The skilled addressee is further to appreciate that apparatus 10 enables customisation of cyclist ergonomics according to requirements. For example, a cyclist seating position can be adjusted to target specific muscle activation during cycling, which may improve cycling performance, facilitate in injury recuperation, and/or the like.

Importantly, apparatus 10 facilitates stability for use on an indoor bike trainer, particularly where lack of both wheels rotating and bicycle forward motion promotes stability due to gyroscopic effects and angular momentum. In addition, apparatus 10 is typically quickly and easily removable to allow conventional use of the bicycle off the trainer 38.

Optional embodiments of the present invention may also be said to broadly consist in the parts, elements and features referred to or indicated herein, individually or collectively, in any or all combinations of two or more of the parts, elements or features, and wherein specific integers are mentioned herein which have known equivalents in the art to which the invention relates, such known equivalents are deemed to be incorporated herein as if individually set forth. In the example embodiments, well-known processes, well-known device structures, and well-known technologies are not described in detail, as such will be readily understood by the skilled addressee.

The use of the terms “a”, “an”, “said”, “the”, and/or similar referents in the context of describing various embodiments (especially in the context of the claimed subject matter) are to be construed to cover both the singular and the plural, unless otherwise indicated herein or clearly contradicted by context. The terms “comprising,” “having,” “including,” and “containing” are to be construed as open-ended terms (i.e., meaning “including, but not limited to,”) unless otherwise noted. As used herein, the term “and/or” includes any and all combinations of one or more of the associated listed items. No language in the specification should be construed as indicating any non-claimed subject matter as essential to the practice of the claimed subject matter.

Spatially relative terms, such as “inner,” “outer,” “beneath,” “below,” “lower,” “above,” “upper,” and the like, may be used herein for ease of description to describe one element or feature's relationship to another element(s) or feature(s) as illustrated in the figures. Spatially relative terms may be intended to encompass different orientations of the device in use or operation in addition to the orientation depicted in the figures. For example, if the device in the figures is turned over, elements described as “below” or “beneath” other elements or features would then be oriented “above” the other elements or features. Thus, the example term “below” can encompass both an orientation of above and below. The device may be otherwise oriented (rotated 90 degrees or at other orientations) and the spatially relative descriptors used herein interpreted accordingly.

It is to be appreciated that reference to “one example” or “an example” of the invention, or similar exemplary language (e.g., “such as”) herein, is not made in an exclusive sense. Various substantially and specifically practical and useful exemplary embodiments of the claimed subject matter are described herein, textually and/or graphically, for carrying out the claimed subject matter.

Accordingly, one example may exemplify certain aspects of the invention, whilst other aspects are exemplified in a different example. These examples are intended to assist the skilled person in performing the invention and are not intended to limit the overall scope of the invention in any way unless the context clearly indicates otherwise. Variations (e.g. modifications and/or enhancements) of one or more embodiments described herein might become apparent to those of ordinary skill in the art upon reading this application. The inventor(s) expects skilled artisans to employ such variations as appropriate, and the inventor(s) intends for the claimed subject matter to be practiced other than as specifically described herein.

1. Bicycle handlebar extension apparatus comprising:
a strut arrangement having a lower end configured to releasably engage a front wheel of a bicycle and an upper end configured to releasably engage a handlebar stem of said bicycle; and
a brace hingedly attached at a bottom end thereof to the upper end of the strut arrangement, said brace defining at a top end thereof a pivotable receptacle configured to receive handlebars, wherein the strut arrangement operatively engaged with the front axle and handlebar stem provides stationary stability to the bicycle whilst angles between the strut arrangement, brace and receptacle are adjustable to facilitate desired rider ergonomics.

2. Apparatus of claim 1, wherein the strut arrangement comprises two struts operatively locatable on either side of a front wheel of the bicycle in order to straddle said wheel.

3. Apparatus of either of claim 1 or 2, wherein the strut arrangement is configured to abut against a frame of the bicycle in order to impede the front wheel from swivelling, i.e. turning from side-to-side.

4. Apparatus of any of claims 1 to 3, wherein the strut arrangement engages with an axle of the front wheel.

5. Apparatus of claim 4, wherein the lower end of the strut arrangement is configured to releasably engage the front axle by means of a quick-release attachment.

6. Apparatus of either of claim 4 or 5, wherein the strut arrangement is configured to engage the front axle by defining axle apertures for receiving said axle therethrough.

7. Apparatus of any of claims 4 to 6, wherein the strut arrangement is biased to sandwich the front axle between respective struts straddling the front wheel.

8. Apparatus of any of claims 1 to 7, wherein the strut arrangement includes a clamp assembly configured to clamp onto the front wheel.

9. Apparatus of claim 8, wherein the clamp assembly is positioned between the two struts proximate the upper end of the strut arrangement, the clamp assembly arrestably slidable along the strut arrangement to facilitate clamping onto front wheels of varying sizes.

10. Apparatus of claim 9, wherein the clamp assembly is arrestable by means of an infinitely adjustable releasable detent.

11. Apparatus of any of claims 1 to 10, wherein the strut arrangement includes a front wheel cradle at the lower end thereof, said cradle configured to receive the front wheel therein.

12. Apparatus of claim 11, wherein the front wheel cradle defines a support foot configured to support the bicycle on a level surface.

13. Apparatus of any of claims 1 to 12, wherein the strut arrangement is configured to be lengthwise adjustable to enable fitment to various sized bicycles, e.g. telescoping struts, or the like.

14. Apparatus of any of claims 1 to 13, wherein the upper end of the strut arrangement is configured to releasably engage the handlebar stem by defining a friction-fit or interference-fit clip to clip onto said handlebar stem.

15. Apparatus of any of claims 1 to 14, wherein the upper end of the strut arrangement is configured to releasably engage the handlebar stem by means of a suitable clamp.

16. Apparatus of claim 15, wherein the brace comprises two beams extending from the strut arrangement to the handlebar receptacle.

17. Apparatus of either of claim 15 or 16, wherein the brace is configured to be lengthwise adjustable to enable ergonomic adjustment e.g. telescoping brace, or the like.

18. Apparatus of any of claims 1 to 17, wherein the pivotable receptacle is configured to receive a variety of bicycle handlebars, as required.

19. Apparatus of any of claims 1 to 18, which includes handlebars received within the receptacle.

20. Apparatus of claim 19, wherein the handlebars comprise triathlon bars.

21. Apparatus of any of claims 1 to 20, wherein the hinge at the bottom end of the brace and the pivotable receptacle are adjustable and releasably securable in order to adjust said angles between the strut arrangement, brace and receptacle.

22. A bicycle exercise arrangement comprising:
a bicycle mounted on a stationary bicycle trainer stand; and
a bicycle handlebar extension apparatus comprising a strut arrangement having a lower end releasably engaged with a front wheel of the bicycle and an upper end releasably engaged with a handlebar stem of said bicycle, and a brace hingedly attached at a bottom end thereof to the upper end of the strut arrangement, said brace defining at a top end thereof a pivotable receptacle configured to receive handlebars, wherein the strut arrangement operatively engaged with the front axle and handlebar stem provides stationary stability to the bicycle whilst angles between the strut arrangement, brace and receptacle are adjustable to facilitate desired rider ergonomics.

23. A bicycle exercise arrangement comprising a bicycle including handlebar extension apparatus in accordance with any of claims 1 to 21.
